(19) United States
(12) Patent Application Publication
(10) Pub. No.: US 2010/0201584 A1
(43) Pub. Date: Aug. 12, 2010

(54) METHOD FOR AUTOMOBILE ROOF EDGE MOUNTED ANTENNA PATTERN CONTROL USING A FINITE FREQUENCY SELECTIVE SURFACE

(75) Inventors: James H. Schaffner, Chatsworth, CA (US); Clair Rayanne Seager, New York, NY (US); Hui-Pin Hsu, Northridge, CA (US); Timothy J. Talty, Beverly Hills, MI (US)

Correspondence Address: MILLER IP GROUP, PLC;GENERAL MOTORS CORPORATION, 42690 WOODWARD AVENUE, SUITE 200, BLOOMFIELD HILLS, MI, 48304, US

(73) Assignee: GM GLOBAL TECHNOLOGY OPERATIONS, INC., Detroit, MI (US)

(21) Appl. No.: 12/368,079

(22) Filed: Feb. 9, 2009

(51) Int. Cl. H01Q 1/32

(52) U.S. Cl. 343/713

(57) ABSTRACT

An antenna for a vehicle where the antenna is positioned close to an edge of a roof-top of the vehicle. A frequency selective surface is provided on a glass of the vehicle, generally the vehicle windshield, to extend the antenna ground plane beyond the roof-top to maintain a maximum antenna pattern directivity parallel to the ground. The frequency selective surface may be formed on a substrate that is adhered to the vehicle glass and includes a pattern of conductive portions and dielectric portions that provide proper current generation for the particular antenna frequency band of interest.

### BACKGROUND OF THE INVENTION

1. Field of the Invention

This invention relates generally to an antenna for a vehicle and, more particularly, to an antenna for a vehicle that is positioned proximate to an edge of a roof-top of the vehicle, where the antenna includes a frequency selective surface placed on a window of the vehicle to increase the size of the ground plane of the antenna to provide an antenna pattern that is more directed along the ground.

2. Discussion of the Related Art

Modern vehicles employ various types of antennas to receive and transmit signals for different systems, such as terrestrial radio, cellular telephone, satellite radio, TCS, AMPS, GPS, etc. Many times the antennas used for these purposes are mounted on a roof of the vehicle so as to provide maximum reception capability. The roof of the vehicle is typically made of a conductive metal that operates as a ground plane for the antenna, and as such controls its directivity. The antenna pattern generated by the antenna for both transmission and reception purposes is formed by currents on the antenna and the roof ground plane. Because the signal source of many communications services originates from towers on the ground (as opposed to satellite signals), it is desirable that the antenna pattern be maximum along the ground to provide the best reception gain and transmission directivity.

Because the roof ground plane for a vehicle antenna contributes to the antenna pattern shaping, it is typically desirable to position the antenna at a location on the vehicle roof where a sufficient roof ground plane is provided in all directions. However, for some vehicle designs, it may be desirable to position the antenna close to the edge of the roof of the vehicle, which limits the size of the ground plane in at least one direction. In this configuration, the edge of the roof has a scattering or diffractive effect on the antenna pattern as a result of currents generated at the edge. This effect typically causes the antenna pattern to be directed more upward depending on a number of factors including the frequency of the signal and how close the antenna is to the edge. When the maximum of the antenna pattern is directed more upward rather than parallel to the ground, signal loss can occur because of the directivity of the antenna pattern Thus, because antenna reception is limited by the location of the antenna, the design of the vehicle is limited by the position of the antenna.

### SUMMARY OF THE INVENTION

In accordance with the teachings of the present invention, an antenna for a vehicle is disclosed where the antenna is positioned close to an edge of a roof-top of the vehicle. A frequency selective surface is provided on a glass of the vehicle, generally the vehicle windshield, to extend the antenna ground plane beyond the roof-top to maintain a maximum antenna pattern directivity parallel to the ground. The frequency selective surface may be formed on a substrate that is adhered to the vehicle glass and includes a pattern of conductive portions and dielectric portions that provide proper current generation for the particular antenna frequency band of interest.

Additional features of the present invention will become apparent from the following description and appended claims, taken in conjunction with the accompanying drawings.

### BRIEF DESCRIPTION OF THE DRAWINGS

FIG. 1 is a side view of a vehicle including a roof-top antenna depicting radiation patterns of the antenna;

FIG. 2 is a front view of a portion of a vehicle roof-top and a windshield of the vehicle including a frequency selective surface provided on the windshield of the vehicle;

FIG. 3 is a cross-sectional view of the antenna, vehicle roof-top and frequency selective surface shown in FIG. 2; and

FIG. 4 is a top view of a frequency selective surface applicable to be used in the antenna shown in FIGS. 2 and 3.

### DETAILED DESCRIPTION OF THE EMBODIMENTS

The following discussion of the embodiments of the invention directed to a vehicle antenna including a frequency selected surface positioned on vehicle glass for increasing the size of the ground plane of the antenna is merely exemplary in nature, and is in no way intended to limit the invention or its applications or uses. For example, the antenna of the present invention has particular application for a roof-top antenna on a vehicle. However, as will be appreciated by those skilled in the art, the antenna of the invention may have application for other antenna configurations other than vehicle antennas.

A frequency selective surface (FSS) is a device for creating a reactive surface, and is typically a periodic metal pattern on a dielectric substrate. In one design, the FSS includes an array of loops with internal meanders. Along the surface of the ground plane and the FSS, the radiation from an antenna can be represented as a transverse magnetic wave (TM) propagating in a radial direction away from the monopole. The equivalent circuit of the loop FSS is a distributed series combination of inductors and capacitors.

This control is achieved by using a finite size reactive surface located on the windshield that connects to the metal roof edge. When the surface reactance is inductive, the phase of the current that is induced in the inductive surface by the antenna radiation is delayed from the current that flows in the metal with ground plane. The result is that the antenna beam is pulled down in elevation towards the windshield. When the reactive surface is capacitive, the opposite happens to the beam pointing direction. By adjusting the reactance of the surface, the beam can be made to point in a horizontal direction with the road. This is the ideal pointing direction for terrestrial based radio reception.

A vertically polarized omni-directional antenna on an infinite ground plane has an azimuth, doughnut shaped pattern with the maximum radiation energy flowing along the surface of the ground plane. Examples of elements that can produce this kind of pattern are monopole, patch, small loop and inverted-F antennas. This is the desired pattern for reception of terrestrial signals by an antenna mounted on the roof of a vehicle. However, when the antenna is placed on a finite size ground plane of a few wavelengths or less, the radiated energy flows away from the ground plane at an angle determine by the frequency and the ground plane dimensions. This is a well known effect caused by diffraction of the radiated field from the ground plane edge along with a noticeable ripple in the pattern. This same effect occurs when the antenna is placed at the edge of a large ground plane where the beam pointing angle is elevated above the ground plane parallel to a line from the antenna perpendicular to the ground plane edge. It is for this reason that the engineering practice for automotive omni-directional antenna placement is generally at the center of the vehicle roof. However, this location is not always practical for antenna placement due to styling or manufacturing concerns. In this case, the antenna must be located closer to the edge of the roof with the potential decrease in omni-directional azimuth pattern performance.

The present invention provides a method for controlling the antenna beam off of the roof edge by placing a skirt of a distributed reactance along the top edge of the windshield, or other vehicle window, closest to the antenna. When the reactance is inductive, the RF currents that flow in the reactive skirt lag in phase from the currents in the ground plane, with the result that the vertically polarized waves radiated from the edge of the skirt combine with the direct antenna radiation to essentially pull the beam down toward the reactive surface. When the reactant is capacitive, the RF currents that flow in the reactive skirt lead in phase from the current in the ground plane and the antenna gain moves in the direction away from the reactive surface. Thus, by adjusting this reactance, the beam pointing angle off of the glass surface can be controlled.

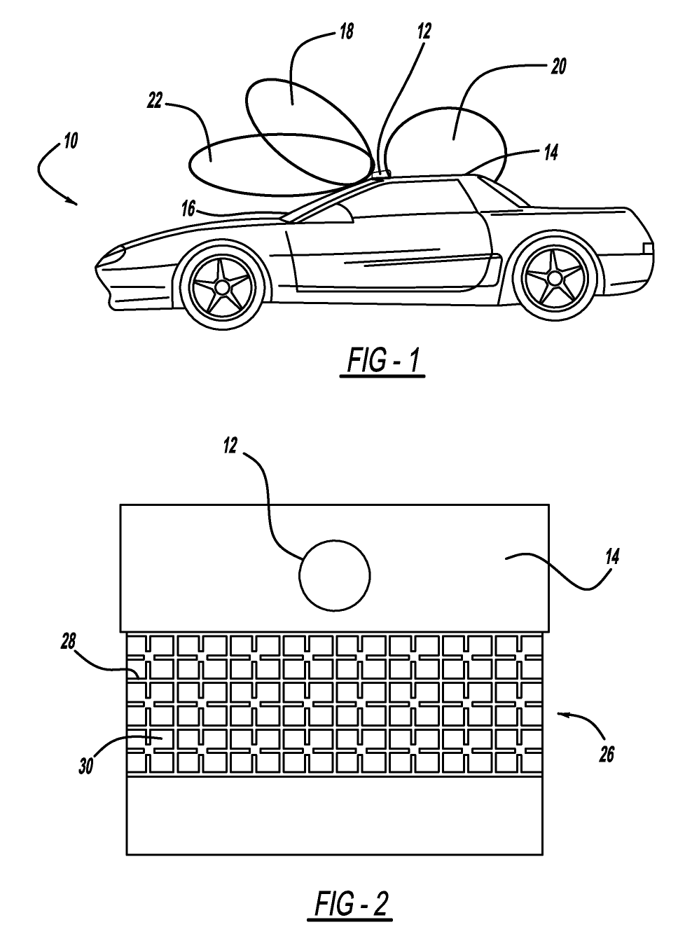

FIG. 1 is a side view of a vehicle 10 including an antenna 12 provided on a roof-top 14 of the vehicle 10. The antenna 12 is positioned towards the front of the roof-top 14 proximate to a windshield 16 of the vehicle 10. In this configuration, the edge of the ground plane provided by the roof-top 14 in a direction towards the windshield 16 causes an antenna pattern 18 of the antenna 12 to be directed more upward, as opposed to an antenna pattern 20 facing rearward along the surface of the roof-top 14 that is more parallel to the ground. The antenna 12 can be any antenna suitable for the purposes discussed herein, such as a monopole, patch, small loop and inverted-F antennas. As will be discussed below, the present invention proposes using a frequency selective surface (FSS) on the windshield 16 that changes the direction of the antenna pattern 18 to be more downward as is the antenna pattern 20.

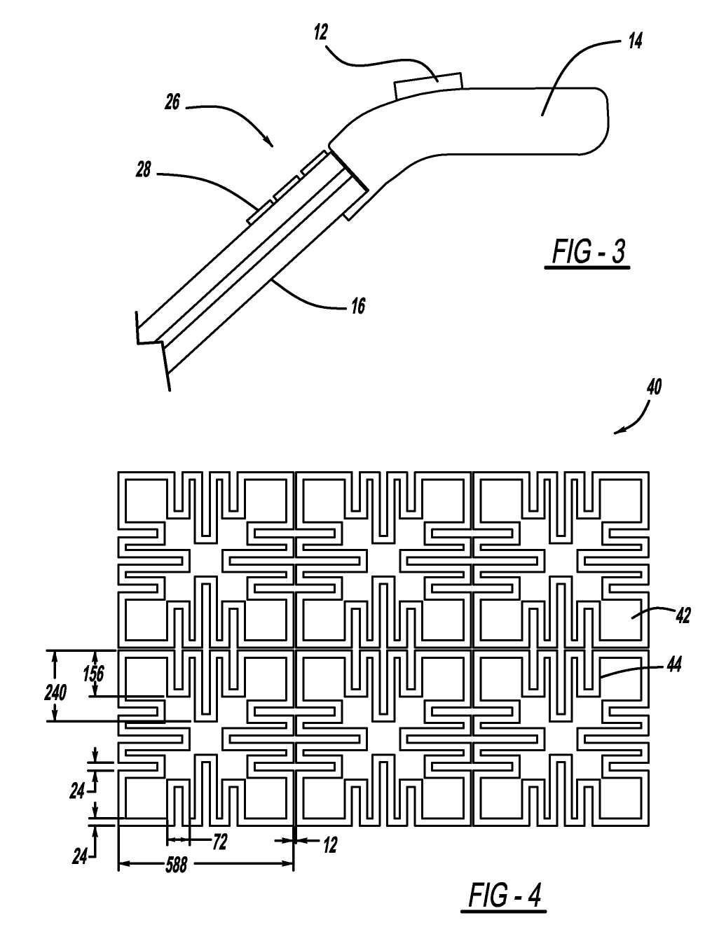

FIG. 2 is a front view and FIG. 3 is a cross-sectional view of a portion of the roof-top 14 of the vehicle 10 showing a portion of the windshield 16 and the antenna 12. According to the invention, the antenna 12 is part of an antenna assembly that includes an FSS 26 formed on a portion of the windshield 16 that operates to extend the antenna ground plane defined by the roof-top 14 over the windshield 16 so that an antenna radiation pattern 22 of the antenna 12 is directed more horizontally, as will be discussed in more detail below. In one non-limiting embodiment, it may be desirable to have the antenna 12 positioned at least one wavelength of the frequency band of interest away from the edge of the roof-top 14 to provide the desired ground plane.

In this non-limiting embodiment, the FSS 26 includes a grid array of elements 28 formed on a suitable dielectric substrate 30. The dielectric substrate 30 is adhered to the windshield 16 in any suitable manner, such as by a suitable adhesive. FSSs are known in the art and are provided in a number of configurations depending on the particular application and frequency band being employed. Known frequency selective surfaces have typically been used as filters where they would pass a signal of one frequency and reflect all other frequencies. Although the discussion above refers to the FSS 26 being formed on a dielectric substrate, other embodiments may include the FSS actually being fabricated within the windshield 16 and not necessarily on a substrate.

The elements 28 define a periodic pattern on the substrate 30 that operates in a desirable manner in connection with the radiation pattern of the antenna 12. Particularly, the pattern of the elements 28 induces currents and scattering therein that in connection with the frequency band of the antenna 12 causes the radiation pattern 22 to be pulled down from its vertical orientation to be more horizontal to the ground. Further, the pattern of elements 28 provides a phase component to the radiation pattern 22 that also affects its ability to be oriented in a desirable direction. The FSS 26 is selected for the particular frequency of the antenna 12, where the elements 28 have a certain width and periodicity that is based on that frequency.

On the windshield 16, the length of the FSS 26 would be limited by a need for clear driver visibility out of the windshield 16. Experimental results shows that the FSS 26 should be about 2-3 wavelengths long of the frequency band of interest to obtain beam control. Longer frequency selective surfaces provide better beam control and could be used on other vehicle windows. It is also possible to fabricate the FSS pattern with an optically transparent conductor, such as indium-tin-oxide.

FIG. 4 is a top view of part of a frequency selective surface 40 that is applicable to be used in connection with the antenna element 12 replacing the FSS 28. In this embodiment, the FSS 40 is made up of separate cells 42 each having a pattern of elements 44 that is repeated from cell to cell. Although six cells are shown here, the FSS 40 would include many more cells. The combination of the cells 42 provides the periodicity that is applicable to extend the ground plane provided by the roof-top 14 to draw down the radiation pattern of the antenna 12. Thus, any suitable periodic pattern of elements can be employed for a particular antenna at a particular frequency band, and be made up of any number of suitable cells.

The dimensions of the FSS 40 shown in FIG. 4 are in units of 0.0001″. The resonant frequency of the FSS 40 can be determined through electromagnetic simulation to be 1.93 GHz when the FSS 40 is fabricated on 0.25 inch plexiglas and 1.50 GHz when the FSS 40 is fabricated on glass. Thus, above this resonant frequency of the FSS 40, the FSS 40 would look inductive to the radiation from the monopole antenna.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. An antenna assembly for a vehicle, said vehicle including a vehicle roof, vehicle windows and a vehicle windshield, said antenna assembly comprising:
an antenna mounted on the roof of the vehicle; and
a reactive skirt formed on or in a vehicle window or the vehicle windshield proximate to the antenna element and being an extension of the vehicle roof, said reactive skirt reacting with an antenna pattern generated by the antenna in a manner that causes the antenna pattern to become more horizontal relative to a surface on which the vehicle is traveling.

2. The antenna assembly according to claim 1 wherein the antenna is selected from the group consisting of patch antennas, monopole antennas, small loop antennas and inverted-F antennas.

3. The antenna assembly according to claim 1 wherein the reactive skirt is a frequency selective surface including a periodic pattern of conductive elements.

4. The antenna assembly according to claim 3 wherein the conductive elements of the frequency selective surface are formed on a dielectric substrate that is attached to the vehicle windshield or window.

5. The antenna assembly according to claim 3 wherein the frequency selective surface is formed in the window or windshield.

6. The antenna assembly according to claim 3 wherein the conductive elements form a grid shape.

7. The antenna assembly according to claim 3 wherein the conductive elements include a number of repeating cells of conductive elements.

8. The antenna assembly according to claim 3 wherein the substrate is a transparent substrate.

9. The antenna assembly according to claim 1 wherein the reactive skirt is about 2-3 wavelengths long of a frequency band of interest.

10. The antenna assembly according to claim 1 wherein the antenna is associated with a PCS, an AMPS, a terrestrial radio, a satellite radio or a cellular telephone.

11. An antenna assembly for a vehicle, said vehicle including a vehicle roof and a vehicle windshield, said antenna assembly comprising:
an antenna mounted on the roof of the vehicle near an edge of the roof proximate to the vehicle windshield; and
a frequency selective surface formed on or in the windshield at the edge of the roof proximate to the antenna, said frequency selective surface including a repeating periodic pattern of conductive elements that capacitively and inductively interact with a radiation pattern of the antenna that causes the radiation pattern to be pulled down and be more parallel to the surface on which the vehicle is traveling.

12. The antenna assembly according to claim 11 wherein the antenna is selected from the group consisting of patch antennas, monopole antennas, small loop antennas and inverted-F antennas.

13. The antenna assembly according to claim 11 wherein the conductive elements of the frequency selective surface are formed on a dielectric substrate that is attached to the vehicle windshield.

14. The antenna assembly according to claim 11 wherein the conductive elements include a number of repeating cells of conductive elements.

15. The antenna assembly according to claim 11 wherein the substrate is a transparent substrate.

16. The antenna assembly according to claim 11 wherein the frequency selective surface is about 2-3 wavelengths long of a frequency band of interest.

17. The antenna assembly according to claim 11 wherein the antenna is associated with a PCS, an AMPS, a terrestrial radio, a satellite radio or a cellular telephone.

18. An antenna assembly for a vehicle, said vehicle including a vehicle roof and a vehicle windshield, said antenna assembly comprising:
an antenna mounted on the roof of the vehicle near an edge of the roof proximate to the vehicle windshield; and
a frequency selective surface formed on the windshield at the edge of the roof proximate to the antenna, said frequency selective surface including a repeating periodic pattern of conductive elements formed on a transparent substrate attached to the windshield that capacitively and inductively interact with a radiation pattern of the antenna that causes the radiation pattern to be pulled down and be more parallel to the surface on which the vehicle is traveling.

19. The antenna assembly according to claim 18 wherein the frequency selective surface is about 2-3 wavelengths long of a frequency band of interest.

20. The antenna assembly according to claim 18 wherein the antenna is selected from the group consisting of patch antennas, monopole antennas, small loop antennas and inverted-F antennas.
